(19) United States
(12) Patent Application Publication
(10) Pub. No.: US 2025/0242886 A1
(43) Pub. Date: Jul. 31, 2025

(54) Control System for an Electric Bicycle

(71) Applicant: Robert Bosch GmbH, Stuttgart (DE)

(72) Inventors: Christoph Schumacher, Dusslingen (DE); Merlin Martin Manewald, Reutlingen (DE); Matthias Weinmann, Balingen (DE); Stefan Kuttler, Dusslingen (DE); Benjamin Koenig, Wendlingen (DE); Daniel Baumgaertner, Neustetten (DE); Jochen Mueller, Zimmern (DE)

(21) Appl. No.: 18/685,783

(22) PCT Filed: Aug. 3, 2022
(86) PCT No.: PCT/EP2022/071839

§ 371 Date: Feb. 22, 2024

(30) Foreign Application Priority Data
Aug. 25, 2021 (DE) 10 2021 209 297.7

(51) Int. Cl. B62M 6/45; B62J 50/22; G07C 5/00

(52) U.S. Cl. CPC B62M 6/45; B62J 50/22; G07C 5/008

(57) ABSTRACT

A control system for an electric bicycle includes a drive controller designed to provide drive control of the electric bicycle. The drive control is implemented on the basis of a set of drive parameters. The drive parameters are configurable for one or more assistance modes by way of a user interface.

### PRIOR ART

The present invention relates to a control system for an electric bicycle.

Current electric bicycles typically provide a user with several different assistance modes, which can be selected by the user. However, the potential of different assistance modes is usually only utilized to a limited extent.

To this end, the present invention discloses a control system which is intended to provide improved assistance to a user of an electric bicycle.

### DISCLOSURE OF THE INVENTION

The control system for an electric bicycle according to the invention comprises a drive controller which is arranged to provide drive control of the electric bicycle, wherein the drive control is based on a set of drive parameters, wherein the drive parameters are configurable for one or more assistance modes by means of a user interface.

The drive control is used to control those components of the bicycle that affect the propulsion of the bicycle. In particular, the drive control provided by the drive controller is used to control a motor and/or a brake system of the bicycle.

The drive control is based on a set of values for the drive parameters, also referred to as a set of drive parameters. A set of drive parameters is assigned to each assistance mode. If several different assistance modes are provided by the control system, a set of drive parameters is stored for each assistance mode. Assistance mode is also known as assist mode. Examples of assistance modes are ECO, Tour, Sport and Turbo.

A drive parameter is a parameter that is used directly or indirectly for drive control. A drive parameter is not necessarily a controlled variable or a value for a controlled physical variable. A drive parameter is a parameter that is stored to determine the behavior of the drive control and is used, for example, to determine control variables such as the supply voltage or current of the motor.

The control system for the electric bicycle is not necessarily located entirely on the electric bicycle and may consist of several components.

The user interface is preferably provided by a component of the control system. In particular, the user interface is an interface that allows a user to make an input in order to configure the control system. The user interface is provided in particular via a mobile device, such as a smartphone or tablet. The user interface is preferably provided by means of an app on the mobile device. Alternatively or additionally, the user interface is provided via a control unit located on the bicycle.

The dependent claims disclose preferred embodiments of the invention.

Preferably, the control system is arranged to perform an automatic change between different selectable assistance modes, so that after the change, the drive control is based on the set of drive parameters of the assistance mode that has been switched to. In other words, this means that the control system is set up to first perform drive control in accordance with a first assistance mode and then automatically, i.e. without user intervention, change from the first assistance mode to a second assistance mode in order to perform drive control in accordance with the second assistance mode. A selectable assistance mode is in particular an assistance mode that can also be selected manually by a user. Optionally, the selectable assistance mode is an assistance mode that can only be selected automatically by the control system.

In particular, the change is linked to conditions that define when the automatic change is executed. The change is particularly dependent on at least one decision parameter. In particular, a condition is defined for the decision parameter and the automatic change occurs when the condition is met. In particular, the condition defines a threshold value for a decision parameter. The decision parameter is in particular a recorded measured value or an operating parameter of the bicycle. Exemplary decision parameters are a state of charge (SOC) of a battery of the bicycle, a detected gradient, a rider pulse, an average riding performance, a speed, a cadence and/or a selected gear ratio.

Preferably, the automatic change is dependent on at least one condition, which can be configured using the user interface. In particular, the user can set a threshold value for an associated decision parameter. The user can also configure the system by preselecting possible conditions. The condition does not have to be directly visible to the user if it is stored in a configuration option.

It is also advantageous if the control system is set up to receive and/or transmit the set of drive parameters associated with an assistance mode via an interface, where in the interface is
an interface to a telecommunications network, a smartphone or a server of an online platform. This makes it possible, for example, to share a self-configured set of drive parameters with other users. In particular, this makes it possible to provide and download drive parameters of an assistance mode via social media. In particular, the fact that a set of drive parameters can be received via an interface makes it possible for an assistance mode to be applied to the control system and thus to the bicycle via an electronic path without having to be modified or created by a user. In particular, new assistance modes can be provided by a manufacturer or another commercial provider in order to expand the functions of the bicycle. Downloading an assistance mode from an online platform also allows the assistance mode to be subjected to a manufacturer-side test, as the set of drive parameters is not created locally by a user. The Internet in particular is to be understood as a telecommunications network.

The interface is optionally a camera. For example, a set of drive parameters is encoded in a QR code or in another computer-readable code and is read by a camera of the control system, which is located on a smartphone, for example, and provided to the drive controller for drive control. Alternatively, a download of an assistance mode from a server is triggered by the QR code.

Furthermore, it is advantageous if the drive parameters of an assistance mode received via the interface cannot be configured by a user. In this way, it can be ensured that drive parameters are not changed in a way that contradicts the technical capabilities of the electric bicycle. Copy protection can also be created in this way, as commercially sourced drive modes cannot be transferred to other bikes by copying individual values, for example.

It is also advantageous if the control system is set up to send an identifier describing the control system via the interface before possibly receiving or sending the set of drive parameters associated with an assistance mode via the interface. This enables, for example, the drive parameters on the device from which the set of drive parameters is received by the control system via the interface to be checked to determine whether the set of drive parameters is suitable for the downloading control system.

It is also advantageous if the control system is set up to deactivate or delete the set of drive parameters of an assistance mode received via the interface after a predetermined period of time, wherein the predetermined period of time is preferably received as a data set together with the received drive parameters of the assistance mode. This means that an assistance mode can no longer be used by a user after a specified period of time. In this way, certain assistance modes can only be provided for certain time intervals, for example.

It is also advantageous if the control system is set up to provide the user with an assistance mode associated with the position for use depending on the position of the bicycle, for example by downloading the assistance mode to the control system. It is also advantageous if the control system is set up to indicate to a user in which area a particular assistance mode is downloaded or used particularly often.

It is advantageous if a crank length and/or a rider's weight can be configured as drive parameters via the user interface and the drive control is based on the configured crank length and/or the configured rider's weight. It is advantageous if the crank length can be configured using a slider, which, for example, allows a choice between the typical crank lengths “Short Crank” of 155 mm and “Regular Crank” of 175 mm. Furthermore, it is advantageous if the weight of the rider can be configured using a slider, which for example allows a selection between two descriptive parameters, such as “light” and “heavy” or “wiry and strong”, or between two weight values, such as “20 kg” and “120 kg”. The weight of the rider is therefore not necessarily an indication in kilograms, but can also be regarded as a relative indication from which the weight of the rider can be inferred. Both the crank length and the weight of the rider have a strong influence on the riding behavior of the bicycle and on how motor assistance is perceived by the user. If these parameters are provided to the control system and thus to the drive controller, the drive control can be optimally adjusted to the user and the bicycle. In particular, the system selects its own characteristic curves according to which assistance is provided by the bicycle's motor in order to adjust the drive control to the crank length and/or the rider's weight.

It is advantageous if the drive control is set up to control a motor assistance provided by the motor of the electric bicycle, wherein the motor assistance is selected based on the configured crank length, wherein a stronger motor assistance is preferably provided for a configured first crank length than for a comparatively larger configured second crank length, and/or wherein the motor assistance is selected based on the configured weight, wherein a stronger motor assistance is preferably provided for a configured first weight than for a configured second weight.

It is advantageous if an operating parameter of a hill start aid or a push aid can be configured as a drive parameter via the user interface. Hill start assist is also known as “hill hold”. Exemplary operating parameters are the ability to activate the hill start aid, a selection of a button for activating the hill start aid, a time interval over which the bicycle is prevented from rolling backwards using the hill start aid, a behavior of a reduction in a maximum motor torque, a behavior of a permitted increase in a negative rotational speed of the motor, a maximum motor torque or rear wheel torque, an gradient at which the hill start aid becomes active, a dependence of a maximum motor torque on an incline, a button for deactivating the hill start aid, a maximum reverse speed, a signaling of the state of the hill start aid and/or a mass of the bicycle or the rider. Based on the operating parameters, the drive of the electric bicycle is controlled by the drive controller. When entering the operating parameters, it is not absolutely necessary for the exemplary operating parameters described above to be provided directly to the user as a value. Abstract inputs can also be recorded and converted into values. For example, a user enters the weight of the rider as a selection between the options “heavy” and “light”, wherein it is not necessary to specify the exact weight in kilograms.

It is also advantageous if the user interface can be used to configure a pushing behavior as a drive parameter. The pushing behavior is a behavior of a so-called “extended boost”. The pushing behavior describes the pushing of the electric bicycle's motor when the rider stops pedaling, but the motor continues to provide temporary assistance, which is referred to as pushing.

In particular, the time interval over which the motor continues to provide assistance after the rider no longer applies torque can be configured. For example, a tendency to push longer is helpful on rough trails to overcome obstacles with short pedal strokes. However, the desired duration and strength, or the desired general characteristics, of the pushing vary greatly. Therefore, it is advantageous to be able to configure the pushing behavior as a drive parameter.

The pushing behavior is defined in particular by a duration or distance that defines how long the motor should push on. Optionally, the pushing behavior is defined by a force, for example as the ratio of a motor torque before and during pushing. Optionally, the pushing behavior is defined by a ratio of the rider's energy input before pushing to the power output during pushing. It is also advantageous if the configured pushing behavior has a threshold value for the rider's energy input above which pushing starts. The threshold value can be dependent on a configured or recorded weight of the rider or a configured crank length.

Furthermore, it is advantageous if the control system is set up to detect a user's riding behavior or an environmental condition during operation of the electric bicycle and to adjust the set of drive parameters based on the detected riding behavior or to create a new set of drive parameters. In this way, the behavior of the drive control is automatically adjusted to the user. It is advantageous if a confirmation by a user is carried out before the drive parameters are adjusted. This makes it easier for the user to access the settings and increases the attractiveness of configurable drive modes. More complex assistance modes can be configured or created using intuitive recommendations.

The riding behavior of a user is recorded in particular via any sensor system, especially via an analysis of the measured values recorded by the sensor system over a period of time. In particular, the set of drive parameters is repeatedly adjusted until a certain operating state of the bicycle no longer occurs. For example, it analyzes whether a user exhibits a certain predefined behavior in a specific riding situation. If this is the case, the drive control is modified by adjusting the drive parameters so that this behavior of the user no longer occurs in the specific riding situation.

An environmental condition is a condition that describes the bicycle's surroundings. For example, the surface on which the bicycle is currently being ridden is detected by position tracking, an initial sensor system or a rider torque. For example, a surface condition is recorded as an environmental condition.

### BRIEF DESCRIPTION OF THE DRAWINGS

Exemplary embodiments of the invention are described in detail in the following with reference to the accompanying drawings. The drawings show:

FIG. 1 an exemplary representation of a control system according to the invention,

FIG. 2 an example of a state of charge curve during operation of an electric bicycle,

FIG. 3 an example of the gradient of a road surface when the electric bicycle is in operation,

FIG. 4 a first exemplary configuration element,

FIG. 5 a second exemplary configuration element,

FIG. 6 a third exemplary configuration element, and

FIG. 7 a flow chart for an exemplary method for adjusting or setting drive parameters based on a detected riding behavior.

### EMBODIMENTS OF THE INVENTION

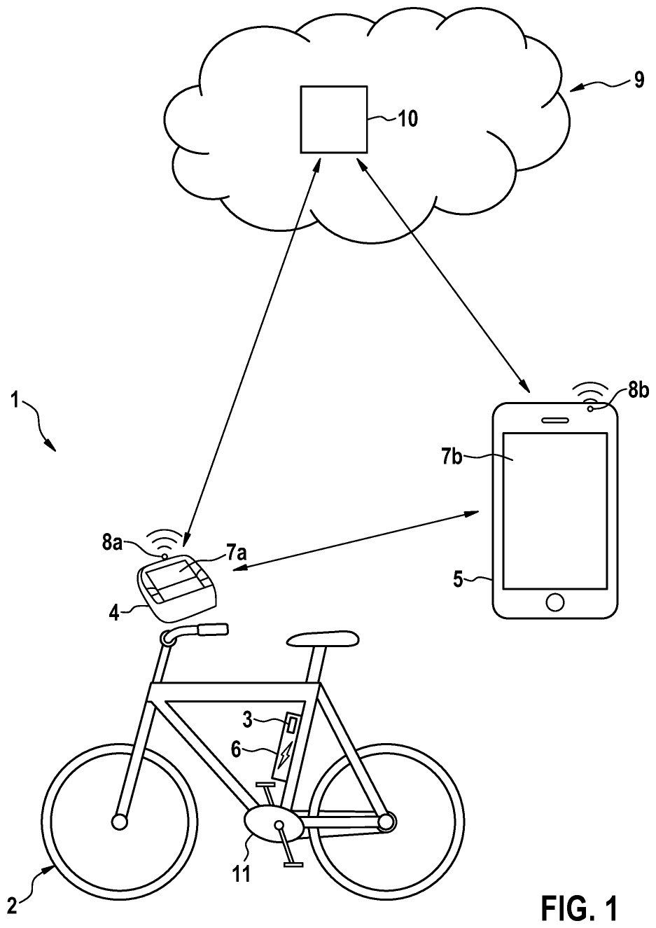

FIG. 1 shows a control system 1 according to an embodiment of the invention. The control system 1 comprises an operating unit 4, which is arranged on an electric bicycle 2 and enables the electric bicycle 2 to be operated. A battery unit 6 and an electric motor 11 are arranged on the electric bicycle 2. A drive controller 3 is also arranged on the battery unit 6, which is set up to provide drive control of the electric bicycle 2. The motor 11 is controlled by the drive controller 3. The drive control is based on a set of drive parameters, wherein the set of drive parameters is assigned to a selectable assistance mode, which can be selected by a user by means of the operating unit 4.

The operating unit 4 is preferably a dedicated unit which can be connected to the electric bicycle 2, for example by means of a plug-in interface, and is therefore typically regarded as a component of the electric bicycle 2. Alternatively, the operating unit 4 is a mobile terminal device which communicates with the drive controller 3, for example by means of a wireless interface such as Bluetooth.

In preferred embodiments, a mobile unit, for example a smartphone 5, is set up to communicate with the operating unit 4 of the electric bicycle 2. The operating unit 4 and the drive controller 3 are configured using an app loaded onto the smartphone 5.

The drive parameters for an assistance mode can be configured using a user interface 7a, 7b. The drive parameters associated with an assistance mode are referred to as a set of drive parameters. The user interface 7a, 7b is provided either via the operating unit 4 or via the smartphone 5. A user therefore has the option of configuring the drive parameters for an assistance mode by means of a user interface 7a of the operating unit 4 or by means of a user interface 7b of the smartphone 5.

The user interface 7a, 7b is thus provided by the operating unit 4 or alternatively by the smartphone 5.

A user interface is a human-machine interface, which is also referred to as a “user interface”. Drive parameters that are configured by the user on the user interface 7b of the smartphone 5 are preferably first transmitted to the operating unit 4 and provided by it to the drive controller 3. The operating unit 4 or the smartphone 5 can also be used to adjust or convert the drive parameters into parameters that can be processed by the drive controller 3.

The control system 1 preferably carries out a method for automatically changing between the selectable assistance modes. Thus, the control system 1 is set up to perform an automatic change between different selectable assistance modes so that the drive control after the change is based on the set of drive parameters of the assistance mode which was changed to.

For example, the electric bicycle 2 is used by a user, wherein a first assistance mode is selected and the drive control is based on the set of drive parameters of the first assistance mode. The control system 1 continuously checks whether a condition occurs that should trigger a change to a second assistance mode. If the condition occurs, the assistance mode is changed and the drive control is based on the set of drive parameters associated with the assistance mode to which the change was made. For example, the system automatically changes from the first assistance mode to a second assistance mode when the condition occurs. Accordingly, the drive control after the change is based on the set of drive parameters of the second assistance mode.

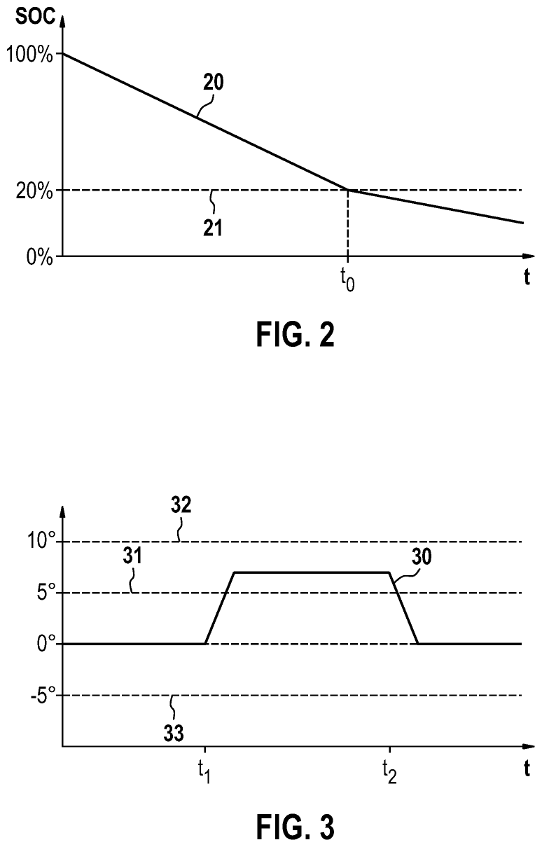

The condition can be configured using the user interface 7a, 7b. For example, it is possible for a user to make a selection before riding the electric bicycle 2 using the smartphone 5, which selects the condition in which a change between different drive assistance modes takes place during the ride. Exemplary conditions, which can preferably also be configured by a user, are described by way of example in FIGS. 2 and 3.

In the example shown in FIG. 2, the condition is a threshold value 21 of a charge state. The state of charge is also referred to as the “State of Charge”, or SOC. The threshold value 21 was selected by one user at 20%. The value of 20% should be regarded as an example, as the user can also configure other values, preferably within a predefined interval. FIG. 2 shows a charge state progression 20 over time during operation of the electric bicycle 2. At the start of the journey, the charge status is 100%. However, this decreases over the operating time of the electric bicycle 2 until it equals the threshold value 21 configured by the user at a point in time t0. The control system 1 recognizes that the condition has occurred under which an automatic change between different assistance modes is to be executed. At the point in time t0, the system therefore changes from a first assistance mode to a second assistance mode. For example, the system changes to a more energy-efficient assistance mode. For example, a change from turbo mode to eco mode. After the point in time t0, the electric bicycle 2 is operated in the second assistance mode by the drive controller 3 and a drive control corresponding to the second assistance mode is executed by the drive controller 3. If the charge level rises again at a later point in time and is above the threshold value 21 again, the assistance mode is optionally reset to the assistance mode that was active before the change at the point in time t0.

In the example shown in FIG. 3, the condition is a first threshold value 31 of an existing gradient. The incline is preferably an incline of a road surface on which the electric bicycle 2 is located, wherein the gradient is detected, for example, via an inclination sensor of the control system 1. The threshold value 31 has been selected by a user at 5 degrees. The value of 5 degrees should be regarded as an example, as the user can also configure other values, preferably within a predefined interval. FIG. 3 shows a gradient curve 30 during operation of the electric bicycle 2 over a period of time. Thus, the electric bicycle 2 is initially operated at an gradient of 0 degrees, wherein the drive of the electric bicycle 2 is controlled in accordance with a first assistance mode. At a first point in time t1, the inclination sensor of the control system 1 detects an increase in gradient. The gradient rises to over 5 degrees and thus exceeds the configured first threshold value 31. This automatically changes from a first assistance mode to a second assistance mode, in which, for example, the user receives more assistance from the motor 11. In the example shown in FIG. 3, the gradient drops again at a second point in time t2, causing an automatic change from the second assistance mode back to the first assistance mode.

Preferably, several conditions, for example several threshold values 31, 32, can be configured by the user. For example, the first threshold value 31 is set at 5 degrees and a second threshold value 32 is set at 10 degrees. For example, if the angle of gradient increases further to a value above 10 degrees, an automatic change to a third assistance mode could take place, in which the user receives more assistance from the motor 11 than in the second assistance mode. A third threshold value 33 is optionally set at −5 degrees. For example, if the gradient angle drops to a value below −5 degrees, there will be an automatic change to a fourth assistance mode, in which the user receives less assistance from the motor 11 than in the first assistance mode. For example, a change to ECO or touring mode.

Some or all of the threshold values 30, 31, 32 are optionally configurable by the user via the user interface 7a, 7b.

The automatic change between different assistance modes is also referred to as “Automatic Mode Change”. The automatic change can be activated and deactivated by the user, for example via one of the user interfaces 7a, 7b. When automatic changing is activated, control system 1 automatically changes between the existing assistance modes. The user can see the currently active assistance mode on a display on operating unit 4. This means that the user always has feedback on the known assistance mode of control system 1. The conditions on the basis of which the automatic change takes place are stored in a configuration. This configuration can, for example, be configured via an app running on the smartphone 5 and transmitted to the drive controller 3 of the electric bicycle 2.

Conditions can be defined and linked with each other for various variables of control system 1. For example, the system changes to an energy-saving assistance mode when the charge level drops below 20%. This condition is optionally marked with a high priority and is used as the preferred decision criterion. Additional conditions can also be configured. For example, an assistance mode is provided on an gradient of less than 5 degrees, which provides assistance that enables particularly long distances to be covered. For example, a tour mode is selected. If the gradient rises above 5 degrees, the system switches to a more supportive assistance mode, such as Sport mode. If the gradient continues to rise, for example above 10 degrees, the system switches to an even more powerful assistance mode, such as turbo mode.

If conditions are selected for different input variables, priorities should be defined. For example, despite a steep gradient of more than 10 degrees, the energy-saving assistance mode is still selected if the selection of a threshold value for the charge status is prioritized as a condition and the charge status simultaneously falls below a threshold value from which the energy-saving assistance mode is automatically selected. By prioritizing the conditions, the conditions described in FIGS. 2 and 3 can be combined in this way, for example.

The automatic change between different operating modes based on the state of charge and based on an existing gradient, as described above with FIGS. 2 and 3, is advantageous, but should only be regarded as an exemplary choice of condition. Alternative or additional conditions may arise based on the following parameters: rider pulse, average rider power, speed, cadence and/or selected gear ratio. For example, a user engages an easier gear when there is a steep gradient ahead. As a result, the system automatically switches to a more powerful assistance mode.

Users can fall back on predefined configurations or create their own configurations and adjust the conditions to suit their requirements.

Optionally, the control system 1 can be used to download or provide drive parameters externally. The control system 1 is preferably set up to receive and/or transmit the set of drive parameters associated with an assistance mode via an interface 8a, 8b. This makes it possible for the drive parameters of an assist mode, and thus also the assistance mode as such, to be provided by the control system 1 or to be imported into the control system 1.

The interface 8a, 8b is an interface to a telecommunications network 9. This is shown schematically in FIG. 1. For example, the interface 8a, 8b is a radio interface 8a of the operating unit 4. The interface 8a of the operating unit 4 is, for example, a mobile radio interface, which enables the operating unit 4 to upload data to a server 10, for example a server of an online platform, or to receive data from it. Alternatively or additionally, the interface 8a, 8b is an interface 8b of the smartphone 5, in particular an interface to a mobile network to which the smartphone 5 is connected. If the interface 8a, 8b to the telecommunications network 9 is the interface 8b of the smartphone 5, then
it is also possible that the set of drive parameters is first downloaded from a server 10 of the online platform 9 using the smartphone 5 and then the set of drive parameters is forwarded to the operating unit 4 via another wireless connection, for example a Bluetooth connection. In the same way, a set of drive parameters can be transferred from the operating unit 4 to the server 10 via the smartphone S. The server 10 is preferably a server of an online platform.

This makes it possible for a user to share the drive parameters of an assistance mode and thus also entire assistance modes. This can be done via social media, for example. New assistance modes with the associated drive parameters can also be made available to a user in this way. These can either be actively downloaded by a user via the smartphone 5 or via the operating unit 4, or they can be pushed from the server 10 to the control system 1 via a push connection. This means that new assistance modes can be added to control system 1 without the user having to create or configure them themselves.

If an assistance mode with an associated set of drive parameters is received from the control system 1 via the interface 8a, 8b, the assistance mode is optionally digitally identified in order to define whether the assistance mode, i.e. the associated drive parameters of the assistance mode, can be configured, i.e. changed, by a user. This ensures that downloaded assistance modes cannot be modified by a user. For example, assistance modes can also be provided that have drive parameters that cannot be set manually by a user. In this way, assistance modes can be provided which, for example, make optimum use of the technical possibilities of a drive of the electric bicycle 2 without overloading the associated electrical components and mechanical components. This also makes it possible to distribute certain assistance modes commercially.

It is advantageous if an identifier describing the control system 1 is sent via the interface 8a, 8b before the set of drive parameters associated with an assistance mode is received or sent via the interface 8a, 8b. The descriptive identifier is either a serial number of the control system 1 or a code that describes a type of electric bicycle 2. In this way, software of the online platform can determine which drive parameters in a set of drive parameters are permissible for the control system 1 to operate the electric bicycle 2. It is therefore possible, for example, to verify whether certain settings in a set of drive parameters are technically permissible and only those assistance modes that are compatible with the control system 1 are provided via the server 10.

It is also possible for an assistance mode, i.e. the set of drive parameters associated with the assistance mode, to be transferred from the server 10 to the control system 1 together with a data set, wherein the data set defines a predefined time period. If the set of drive parameters and thus the new assistance mode has been installed or activated on the control system, the control system 1 is set up to deactivate or uninstall it again after the time period received with the data set has expired. In other words, this means that a downloaded assistance mode can only be used for a specified period of time. For example, it is conceivable that a certain assistance mode is only available for the duration of a specific event, e.g. during the Olympic Games, and can no longer be accessed or used after the event.

This makes it possible, for example, for a manufacturer to provide new assistance modes with associated drive parameters that can be transferred to the electric bicycle 2 by a user via an app.

It is also possible for certain assistance modes to be provided depending on the location. It also allows several users of different bikes to share assistance modes they have created themselves. If certain assistance modes are to be provided depending on the location, a current position of the electric bicycle 2 is preferably determined by the control system 1, for example using a GPS sensor. If, for example, it is determined that the electric bicycle 2 is located in a mountainous environment, the user can be provided with assistance modes with drive parameters that enable the electric bicycle 2 to operate particularly well on a mountainous route.

The online platform can be either a social network or a platform of a manufacturer of the electric bicycle 2. Whether certain assistance modes can be downloaded by a user for a specific control system 1 may depend on the technical requirements of the electric bicycle 2 or the user's registration. The way in which new assistance modes are presented to the user allows for different options. For example, it is possible for a user to be shown, depending on their location, which assistance modes have been downloaded or used particularly often in this area. It is also possible for new assistance modes to be linked via QR codes and made available via advertisements, for example.

Optionally, one or more of the drive parameters of a set of drive parameters for an assistance mode can be configured by a user. For example, a configuration interface is provided on the user interface 7a, 7b, which comprises one or more configuration elements.

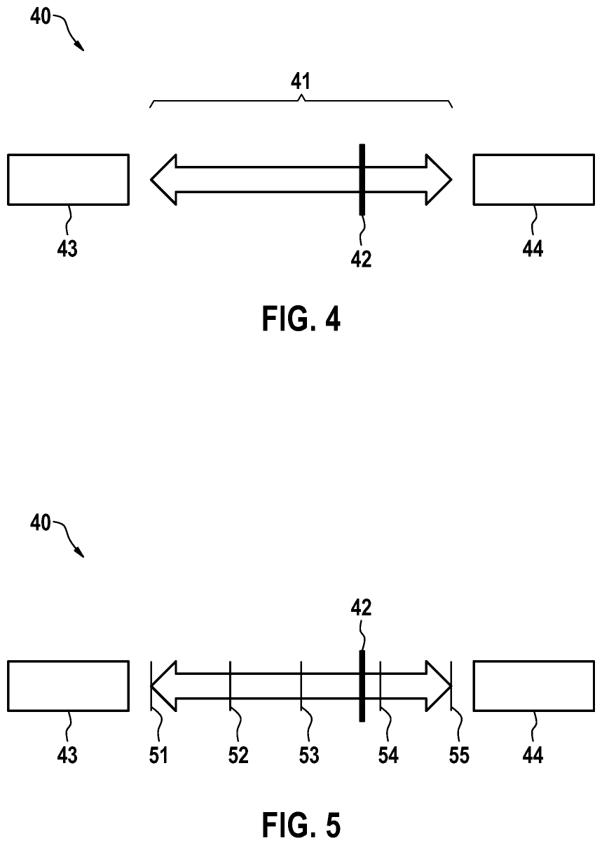

Exemplary configuration elements are shown in FIGS. 4 to 5. For example, the user is provided with a graphical slider 40, wherein the user can make a selection for a value between a minimum value 43 and a maximum value 44 by moving a slider 42 in a selection area 41. The slider 40 optionally comprises a range with scales 51 to 55 to facilitate selection.

A crank length and/or a rider's weight can optionally be configured as drive parameters via the user interface 7a, 7b and the drive control is based on the configured crank length and/or the configured rider's weight.

Both the rider's weight and the crank length have a significant influence on the rider's torque and therefore also on the motor control, which is provided by the drive controller 3. The handling of bicycle 2 varies depending on the weight of the rider and the crank length. For example, it can be assumed that a light rider with a short crank can apply less torque and therefore receives less torque from the motor. It can also be assumed that a heavier rider can generate more power, which has generally led to a higher motor output in the motor management system. This can put light riders at a disadvantage. It is therefore advantageous if the crank length and/or the weight of the rider can be adjusted by the user.

For example, the crank length can be set by selecting one of the configuration elements shown in FIG. 4 or 5, wherein the
minimum value 43 defines a minimum adjustable crank length and the maximum value 44 defines a maximum adjustable crank length. A length for the configurable crank length is optionally given by the scales 51 to 55. For example, a selection of 155 mm, 160 mm, 165 mm, 170 mm and 175 mm is indicated by the scales 51 to 55. A minimum value of 155 mm is specified for a so-called “short crank” and a maximum value of 175 mm is specified for a so-called “regular crank”. Alternatively, slider 42 can be used to select between the short, medium and long options. However, configuration using a slider is only optional. Alternative configuration options are possible, for example, by entering a numerical value or using a drop-down menu.

If a crank length has been configured by the user, this is provided to the drive controller 3 as a drive parameter and the motor 11 of the electric bicycle 2 is controlled based on the selected crank length. In particular in this case, the motor assistance provided by the motor 11 is controlled. This means that the motor assistance is selected based on the configured crank length, with stronger motor assistance preferably being provided for a configured first crank length than for a comparatively longer configured second crank length. More motor assistance is therefore preferably provided with shorter crank lengths than with longer crank lengths.

Motor assistance is provided based on the set crank length if the corresponding assistance mode, for which this crank length is configured, is selected. To control the motor assistance, for example, an assumption is first made for optimum assistance for a predefined crank length. For example, a mountain bike with a crank length of 165 mm is considered to have optimum assistance. This can be done through test drives, for example.

If the user sets a different crank length, for example 155 mm, this leads to an adjustment of the riding behavior. For example, several characteristic curves for the drive control are stored for an assistance mode and an associated characteristic curve is selected by the drive controller 3 for a specific configured crank length. The riding behavior can be adjusted via stored applications, characteristic curves, characteristic maps or similar for all adjustable crank lengths. It is optionally possible to carry out test drives for all conceivable adjustable crank lengths and the motor assistance corresponds to the selected crank length and the associated test drives.

Alternatively, the riding behavior and thus the motor assistance is automatically adjusted by recalculation. The drive controller 3 usually records the motor torque and the driver's cadence, among other things, and calculates the motor torque from this. For example, if the crank length changes by 10 mm from 165 mm to 155 mm, i.e. the crank length changes by approx. 6%, the rider torque is reduced accordingly. However, the rider's cadence generally increases by the same factor, as the rider will provide a similar performance. Experience has shown that a rider with a short crank, i.e. approx. 150 mm, rides with a cadence that is approximately 20% higher than a rider with a regular crank length, i.e. 175 mm crank length. It has also been shown that riding with a short crank length is generally more tiring for the rider than with a regular crank length. A higher level of motor assistance is therefore desirable with a shorter crank length. It is therefore advantageous to adjust a cadence measured by a sensor and a rider torque depending on the crank length for the subsequent calculation of the motor assistance.

Optionally, the user can configure the weight of the rider as a drive parameter. A configuration can be made, for example, according to the configuration elements shown in FIG. 4 or 5. As a minimum value 43, for example, the options “light”, “wiry” or an initial weight specification are given. The maximum value 44 is, for example, the option “heavy”, “strong” or a second weight specification. For example, slider 42 allows a choice between light and heavy, between wiry and strong or between two weights, such as 30 kg and 120 kg.

Experience has shown that the expected riding performance of a user and its distribution between cadence and rider torque also depends on the weight of the rider. A heavier rider will generally apply more torque and tend to pedal more slowly, resulting in a lower cadence. However, a heavier rider will also tend to be able to generate more power. These differences can also be taken into account when calculating the motor assistance and can be neutralized as far as possible. Thus, the motor assistance provided by the motor 11 of the electric bicycle 2 is preferably controlled by the drive control in such a way that a stronger motor assistance is provided for a configured first weight than for a configured second weight. The first weight is preferably less than the second weight.

The user interface 7a, 7b can optionally be used to configure an operating parameter of a hill start assist or a push assist as a drive parameter and the drive control is based on the configured operating parameter when the hill start assist or push assist is active. Configuration is also possible here using the sliders shown in FIG. 4 or 5. The minimum value 43 could therefore be selected as “off”, for example, and the maximum value 44 could be selected as “long” or as a time value, such as “10 seconds”. If the slider 42 is set to the minimum value 44, the hill start assist or the push assist would be deactivated. If the slider is moved to a different value, this defines a time range between 0 and 10 seconds. This time interval corresponds, for example, to the duration for which hill start assist is provided or for which push assist is provided.

By configuring a time interval, the hill start assist can be configured to determine how long reverse rolling is prevented. For example, this configures how an available maximum motor torque is reduced, e.g. whether it decreases linearly. The time interval can also be used to define how a permitted rotational speed of the motor 11 may increase in order to allow targeted reverse rolling. For example, the time interval can define a linear increase between a minimum negative rotational speed and a maximum negative rotational speed. Whether the permitted negative rotational speed or the available maximum motor torque decreases or increases linearly or quadratically can also be configured as an option.

Alternatively or additionally, however, other drive parameters relating to the hill start assist or the push assist can also be configured. For example, an activation can be configured to occur via a dedicated button or button combination. Further possibilities for configuring an operating parameter of a hill start aid comprise configuring the maximum amount of motor torque or rear wheel torque that is used, wherein this is also dependent in particular on a gear ratio and a wheel circumference. It is also optionally possible to configure the gradient at which the hill start assist is activated or to configure a gradient dependency on other parameters of the hill start assist. For example, it is possible to define the maximum motor torque of the motor 11 for a specific gradient. It is also possible to optionally configure that the hill start assist is abruptly terminated when a defined button is pressed. In particular, the button for canceling the active hill start assist is defined, wherein, for example, a selection between all buttons, a specific button, or not cancelable is possible. A maximum reverse speed can also be configured as an option and is limited by the drive control according to the configuration. This can, for example, prevent the bicycle 2 from rolling backwards in an uncontrolled manner. In particular, this setting can also be dependent on the previous activation of a push assist. Optionally, it is possible to configure whether the push assist or the hill start assist are signaled acoustically and how they are signaled. A mass of the bicycle 2 can also be configured as an option. For example, the permitted reverse speed is limited more strongly if a greater mass is configured for the bicycle 2. In particular, this can prevent the bicycle from unintentionally picking up momentum when heavily loaded on a slope.

When configuring the operating parameters of the hill start assist, it is also not absolutely necessary for the user to configure a technical value or a physical variable. The user interface 7a, 7b can be used to provide a configuration option that is easy for the user to understand. For example, the user sets an abstract strength of the hill start assist as an operating parameter for the hill start assist, wherein the slider is set between weak and strong and the actual conversion into a maximum motor torque takes this value into account.

The user interface 7a, 7b can optionally be used to configure a pushing behavior as a drive parameter and the drive control is based on the drive parameter configured for the pushing behavior. The pushing behavior is also referred to as “extended boost”. Pushing refers to the state in which the rider no longer continues to pedal, but the motor 11 of the bicycle 2 continues to provide defined assistance within legal limits. The pushing behavior is controlled by the drive controller 3 in accordance with the drive control, wherein the pushing behavior takes place in accordance with the drive parameters configured for the pushing behavior.

The drive parameters for the pushing behavior can be configured, for example, by means of the sliders shown in FIG. 4 or 5, wherein the value “weak”, for example, is provided as the minimum value 43 and the value “strong”, for example, as the maximum value, and the slider 42 can be used to make an adjustment between these values. In the process, a motor torque provided during the pushing is selected according to the setting of the slider 42. Alternatively or in addition, a duration of the pushing can be configured, wherein, for example, a selection between the minimum value 43 of “short” to the maximum value 44 of “long” can be configured. It is also possible to select between two time values as minimum and maximum values 43, 44. This is used, for example, to set how long a pushing lasts after the user has stopped pedaling.

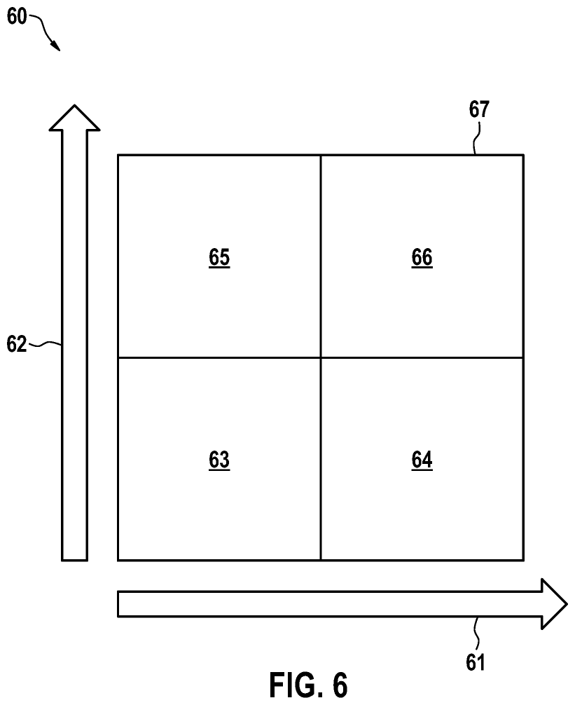

It is also possible to set both the strength of the motor torque and the duration of the pushing behavior and thus configure them. It is optionally possible for a setting to be made in accordance with the configuration element shown in FIG. 6. For example, a first axis 61 is used to select the desired motor torque and a second axis 62 is used to select the desired duration. A field 67 is spanned by the two axes 61, 62 and the user makes a selection by selecting a point in the field 67. This makes it possible to select two parameters with a single tap on the field 67. In a first field 63, for example, a short duration and low motor assistance is selected. In a second field 64, a higher motor torque is selected for the short duration. In the third field 65, the low motor torque is selected for a longer duration. In the fourth field 66, a longer duration with the greater motor torque is selected.

Alternatively or additionally, a ratio of the riding energy introduced before the pushing to the power provided during the pushing is configured. For example, a threshold value can be set for the amount of riding energy applied, at which point the pushing function kicks in. The threshold value can optionally be made dependent on the rider's weight. It is therefore advantageous if the weight of the rider can also be configured by the user. The pushing behavior can alternatively or additionally be made dependent on other boundary conditions, such as an gradient, a surface or a speed. The boundary conditions are preferably recorded by a sensor system of the electric bicycle 2 or an external sensor system. Alternatively or additionally, the pushing behavior is derived from user-related parameters, for example, the strength of the pushing can be derived from an entered weight of the rider and the crank length.

The behavior of a pushing is also defined by the application behavior of the pushing function. This can also be configurable. For example, the slider 42 can be used to select whether a gentle or a coarse application of the pushing should take place.

Alternatively or additionally, the user configures a threshold value of rider energy that the user must provide in a defined period of time prior to pushing in order for pushing to take place at all.

The pushing behavior can also be configured as a drive parameter by configuring the weight of the rider and the crank length of the bicycle 2. For example, the rider's weight and the crank length are used to determine a threshold value that must be exceeded by a previous minimum rider torque in order to activate the pushing function. In this way, it is possible to ensure that the pushing also starts for users with a low weight.

For all examples described here, in which drive parameters are configured, drive control is carried out at a later point in time by the drive controller 3, in which the respective drive parameter is taken into account. Thus, each value entered via the user interface 7a, 7b is to be understood as a drive parameter if it is relayed to the drive controller 3 or if a setting is calculated from this value and provided to the drive controller 3. Optionally, a drive parameter can be adjusted for a configured bicycle type. For example, a pushing function can be stronger on a mountain bike than on a city bike. This applies to all drive parameters described above.

Alternatively or additionally, the control system is set up to detect or analyze a user's riding behavior during operation of the electric bicycle 2 and to adjust the set of drive parameters based on the detected riding behavior or to create or suggest a new set of drive parameters.

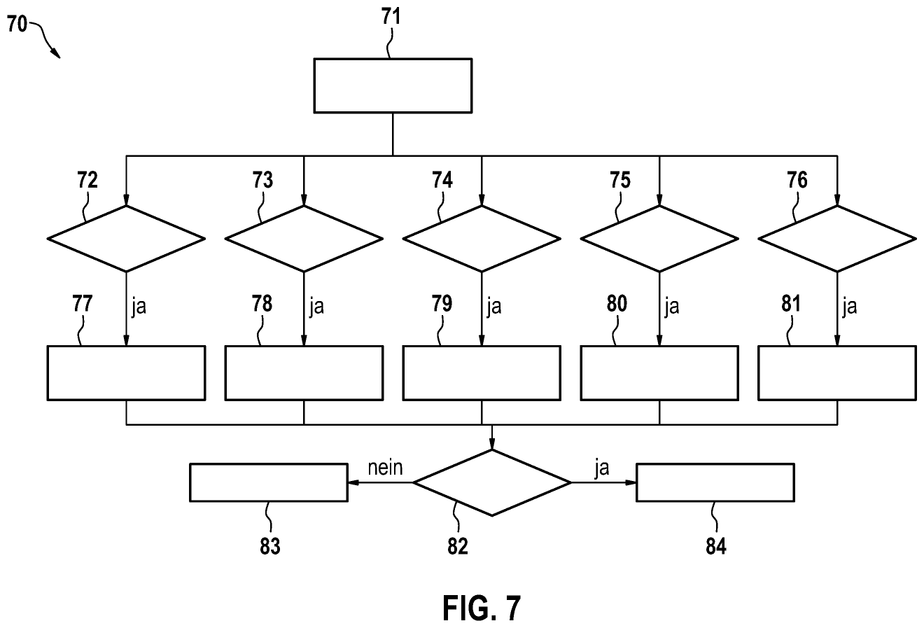

The drive parameters for an assistance mode are created or adjusted using the method shown in FIG. 7, for example.

In the method 70 shown in FIG. 7, a new assistance mode is first created by a user in a first method step 71 or a request is provided that an existing assistance mode is to be modified.

In the following, an analysis of the user's riding behavior is carried out during operation of the bicycle 2. For this purpose, different characteristics of the riding behavior are continuously recorded and analyzed in parallel in a first to fifth analysis step 72 to 76.

In a first analysis step 72, the speed at which the electric bicycle 2 is typically ridden is detected and thus a comfortable speed is determined. If such a comfortable speed is detected, a first adjustment step 77 suggests that a speed recommendation be set to the comfortable speed or that motor assistance be optimized for this speed.

In a second analysis step 73, it is detected whether an abrupt interruption of pedaling occurs during a starting process. If such behavior is detected, a reduction of a dynamic factor and/or an assistance factor for the assistance mode is suggested in response to this in a second adjustment step 78.

In a third analysis step 74, it is detected whether a very high rider torque is present when riding, i.e. the rider torque is above a predefined threshold value. If this is the case, in reaction, an increase in an assistance factor and a maximum motor torque for the active assistance mode is suggested to the user in a third adjustment step 79. Optionally or additionally, a heart rate of the user is detected in the third adjustment step 79 and an adjustment of the assistance factor and maximum motor torque based on the heart rate is suggested in the third adjustment step 79. For example, if the heart rate is very high, an increase in the assistance factor or the maximum motor torque may be suggested.

In a fourth analysis step 75, it is detected whether a very low rider torque is present throughout, for example the rider torque is below a predefined threshold value. If this is the case, a fourth adjustment step 80 is carried out in response. In this fourth adjustment step 80, the user is suggested to reduce the assistance factor and the maximum motor torque.

In a fifth analysis step 76, an environment with high riding resistance is detected. This can be done, for example, by means of a location analysis or a gradient angle. If an environment with high riding resistance is detected, a fifth adjustment step 81 is carried out in response, in which an increase in the assistance factor and the maximum motor torque is suggested.

If one of the adjustment steps 77 to 81 has been carried out, a confirmation step 82 suggests to the user a corresponding adjustment of the selected assistance mode or the creation of a new assistance mode. If this is confirmed by the user, the active assistance mode is adjusted in a storage step 84 according to the parameters determined in the adjustment steps 77 to 81 or a new assistance mode is created with the parameters determined in the adjustment steps 77 to 81. If the memory request to the user is denied in confirmation step 82, all the settings determined are discarded. This is done in a deletion step 83.

This makes it possible to suggest an assistance mode setting to the user based on the riding style, riding situations and other environmental conditions, wherein preferably a reason for the suggested change is also provided. This results in the following advantages: users find it easier to access the possible settings, the adjustable drive parameters and configurable assistance modes become more attractive, and more complex assistance modes can be created thanks to intuitive recommendations.

Inexperienced users in particular are not used to riding faster than a certain speed. If sensors detect that the user always stops pedaling at the same speed, this speed can be suggested as a drive parameter for an assistance mode. This can be measured even more clearly downhill: if bicycle 2 is not accelerated above a certain speed, the user's comfort limit can be determined fairly accurately and communicated accordingly.

An assistance factor, the dynamic factor and the maximum motor torque can also be adjusted. It can be determined in various scenarios whether the motor is set too aggressively or too weakly. Typically, this can be seen when the user pedals, stops pedaling briefly and then continues with a “normal” pedal stroke. In this case, it can be interpreted that the motor assistance was too strong at the beginning and the user therefore stopped pedaling and then pedaled more carefully again. In this case, the start-up may have been too strong and a reduction of the assistance factor and/or the dynamic factor in particular may be recommended. The reduction can be recommended until the riding situation described above no longer occurs.

In some cases, the assistance factor can be adjusted via the speed. In the scenario described, it is conceivable that it is recommended to reduce this assistance factor in the lower speed range.

On the other hand, if very high rider torques occur when starting off or even while riding, it may make sense to increase the factors described above and possibly also the maximum motor torque.

With light riders, only very low rider torques occur and the maximum speed is reached very quickly. In this case, there could be an underload and a reduction in the assistance factor is suggested.

In the previous scenarios, a variant is conceivable that includes the heart rate in this assessment. If a healthy or fitness level is regularly exceeded, the rider is probably overtaxed with the current setting. In this case, a recommendation is given to increase the assistance factor and the maximum torque. It is also conceivable that an assistance mode could be changed gradually and automatically based on the heart rate if the rider agrees to this.

Finally, the environmental conditions should be considered. If GPS, inertial sensors (acceleration or rotation rate) or the rider's torque are used to detect a change in the surface conditions and therefore, for example, more difficult terrain is to be expected, the user is informed that an increase in the assistance factor is recommended. Especially with GPS, preferably with a known route, the advantage is to estimate how long the surface change will last and whether a recommendation is worthwhile at all. In addition, in the case of a trail, it is particularly recommended that the dynamic factor is reduced in combination with the assistance factor in order to have more control. This is because a very dynamic restart could be unfavorable, if not dangerous.

It is also possible to use GPS/maps (also based on time of day) to differentiate between work and leisure routes and provide special UDAM location recommendations. It is usually desirable to cover a distance as effortlessly as possible, which is why a high assistance factor and a high maximum motor torque are appropriate here. In leisure time, fitness and range are often of greater interest, so a recommendation that leads to a lower level of assistance is appropriate.

The changes can generally be recommended until the riding situations described above no longer occur or the user does not agree to a further suggestion.

The environmental conditions can be coupled with the previous recommendations. For example, low rider torques and power are more acceptable on the commute and therefore the threshold values for the recommendations can be more relaxed. If, based on the input signals (e.g. low torque, low speeds, shaky steering angle deflection), a beginner can be assumed, it is recommended to reduce the dynamic factor or the assistance factor in particular.

In addition to the above written disclosure, explicit reference is made to the disclosure of FIGS. 1 to 7.

1. A control system for an electric bicycle, comprising:
a drive controller configured to provide drive control of the electric bicycle,
wherein the drive control is based on a set of drive parameters, and
wherein the drive parameters for one or more assistance modes are configured by way of a user interface.

2. The control system according to claim 1, wherein the control system is further configured to perform an automatic change between different selectable assistance modes, so that the drive control after the change is based on the set of drive parameters of the assistance mode to which the change has been made.

3. The control system according to claim 2, wherein the automatic change is dependent on at least one condition which is configurable by way of the user interface.

4. The control system according to claim 1, wherein:
the control system is set up to receive and/or transmit the set of drive parameters associated with an assistance mode via an interface, and
the interface is an interface to a telecommunications network, a smartphone or a server of an online platform.

5. The control system according to claim 4, wherein the drive parameters of an assistance mode received via the interface is unconfigurable by a user.

6. The control system according to claim 4, wherein the control system is configured to send an identifier describing the control system via the interface before a possible reception or transmission of the set of drive parameters associated with an assistance mode via the interface.

7. The control system according to claim 4, wherein:
the control system is configured to deactivate or delete the set of drive parameters of an assistance mode received via the interface after a predetermined period of time, and
the predetermined period of time is received as a data set together with the received drive parameters of the assistance mode.

8. The control system according to claim 1, wherein a crank length and/or a weight of a rider are configured as drive parameters via the user interface, and
the drive control is based on the configured crank length and/or the configured weight of the rider.

9. The control system according to claim 8, wherein the drive control is suitable for controlling a motor assistance provided by a motor of the electric bicycle, and further wherein:
the motor assistance is selected based on the configured crank length, with a stronger motor assistance being provided for a configured first crank length than for a comparatively greater configured second crank length, and/or
the motor assistance is selected based on the configured weight, wherein a stronger motor assistance is provided for a configured first weight than for a configured second weight.

10. The control system according to claim 1, wherein an operating parameter of a hill start assist or a push assist is configurable as a drive parameter, via the user interface.

11. The control system according to claim 1, wherein the user interface is used to configure a pushing behavior as a drive parameter.

12. The control system according to claim 1, wherein the control system is set up to detect a riding behavior of a user during operation of the electric bicycle and to adjust the set of drive parameters based on the detected riding behavior or to create a new set of drive parameters.
